(19) United States
(12) Patent Application Publication
(10) Pub. No.: US 2021/0086331 A1
(43) Pub. Date: Mar. 25, 2021

(54) SOCKET

(71) Applicants: Kuo-Cheng Wu, TAICHUNG CITY (TW); Chih-Chao Chang, TAICHUNG CITY (TW)

(72) Inventors: Kuo-Cheng Wu, TAICHUNG CITY (TW); Chih-Chao Chang, TAICHUNG CITY (TW)

(21) Appl. No.: 17/115,800

(22) Filed: Dec. 9, 2020

Related U.S. Application Data
(63) Continuation-in-part of application No. 16/128,538, filed on Sep. 12, 2018.

(51) Int. Cl. B25B 13/06

(52) U.S. Cl. CPC B25B 13/065

(57) ABSTRACT

A socket includes multiple protrusions and grooves alternatively formed in the inner periphery of the central hole of the socket. Each protrusion has an encounter face formed on the distal end thereof. The encounter face includes two inclined faces which intersect at a peak point by a top angle. Each protrusion includes two lateral sides which respectively face the grooves corresponding thereto. The two inclined faces respectively intersect the two lateral sides at a corner by a corner angle which is an obtuse angle. An angle of 2 to 9 degrees is defined between each of the inclined face and a chord that passes the peak point and is perpendicular to an axis of the protrusion. The center angle between the two lateral sides of each protrusion is 25 to 44 degrees. The socket effectively drives rounded object and the corners of each protrusions are not damaged.

The present invention is a Continuation-In-Part application of applicant's former patent application with application Ser. No. 16/128,538, filed on Sep. 12, 2008.

### BACKGROUND OF THE INVENTION

### 1. Fields of the Invention

### 2. Descriptions of Related Art

The conventional socket is disclosed in FIG. 13 and includes six faces defined in the central hole thereof so as to accommodate a hexagonal object in the central hole of the socket. In order to easily accommodate the object, the size of the central hole is designed to be slightly larger than the object. When driving the object, because of the size difference between the central hole of the socket and the object, only a portion of each of the faces contacts one of the corners of the object. Therefore, the corners of the object are easily worn out, such that the rounded object cannot be rotated by rotation of the socket. FIG. 14 discloses an improved socket which includes six curved faces in the central hole. The contact area between the curved faces and the sides of the object becomes smaller than the previous socket. FIG. 15 is developed to deal with the shortcoming and includes rectangular protrusions protruding from the inner periphery of the central hole of the socket. Each protrusion includes two right angle corners. The protrusions are able to contact the rounded object with a larger contact area by its encounter face. However, when a large torque is applied, the right angle corners may be direct in contact with the object, and causes damage to the right angle corners.

The present invention is intended to provide a socket that is designed to eliminate the drawbacks mentioned above.

### SUMMARY OF THE INVENTION

The present invention relates to a socket which is a cylindrical body and includes a central hole. Multiple protrusions protrude radially from the inner periphery of the central hole of the socket, and multiple grooves are alternatively defined in the inner periphery of the central hole and located between the protrusions. Each protrusion has an encounter face formed on the distal end thereof. Each encounter face includes two inclined faces which intersect at a peak point by a top angle. Each protrusion including two lateral sides which respectively face the grooves corresponding thereto. The two inclined faces respectively intersect the two lateral sides at a corner by a corner angle which is an obtuse angle. The two inclined faces have an identical width. An angle of 2 to 9 degrees is defined between each of the inclined face and a chord that passes the peak point and does not intersect either of the two inclined faces. The center angle between the two lateral sides of each protrusion is 25 to 44 degrees.

The advantages of the present invention are that the two inclined faces of each protrusion may contact the object in different angular positions which include line-contact and/or area-contact so that the object can be stably rotated by the socket and the object is not likely to be damaged.

The socket is able to drive a rounded object by choosing the socket that includes a larger angle between each of the inclined face and the chord, so that the peak point contacts one of the sides of the object by a line to increase a contact area between the peak point and one of the sides of the object, and to increase a driving force to the object.

The two inclined faces and the two lateral sides protect the corners of each protrusion from being worn out.

When compared with the conventional socket in FIG. 15, the corner angle is an obtuse angle which protects the corners of each protrusion, on the contrary, the corners of the protrusions disclosed in FIG. 15 are a right angle which is easily damaged.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the socket of the present invention;

FIG. 2 is an end cross sectional view of the socket of the present invention;

FIG. 3 is an enlarged view of one of the protrusions of the socket of the present invention;

FIG. 4 shows that the socket of the present invention is engaged with a normal hexagonal object;

FIG. 5 is an enlarged view of the circled portion in FIG. 4;

FIG. 6 shows that the socket of the present invention is engaged with a normal object and rotated counter clockwise;

FIG. 7 is an enlarged view of the circled portion in FIG. 6;

FIG. 8 shows that the socket of the present invention is engaged with a slightly rounded object and rotated counter clockwise;

FIG. 9 is an enlarged view of the circled portion in FIG. 8;

FIG. 10 shows that the socket of the present invention is engaged with a severely rounded object and rotated counter clockwise;

FIG. 11 is an enlarged view of the circled portion in FIG. 10;

FIG. 12 shows that the peak point of one of the protrusions of the socket of the present invention is in contact with a rounded object;

FIG. 13 shows a normal socket received in a conventional socket;

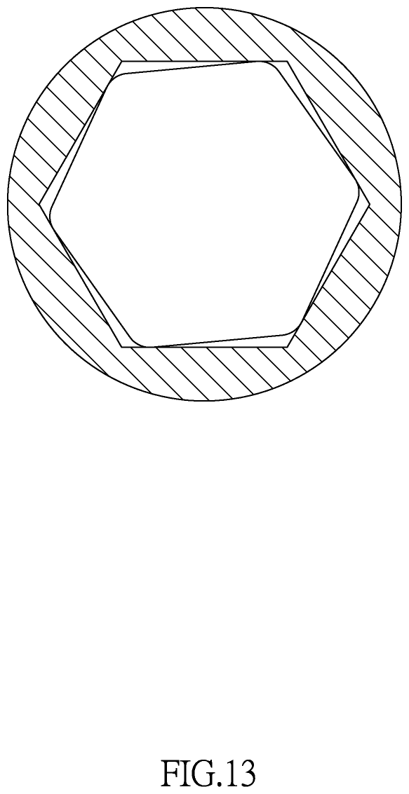

FIG. 14 shows another conventional socket and a rounded socket, and

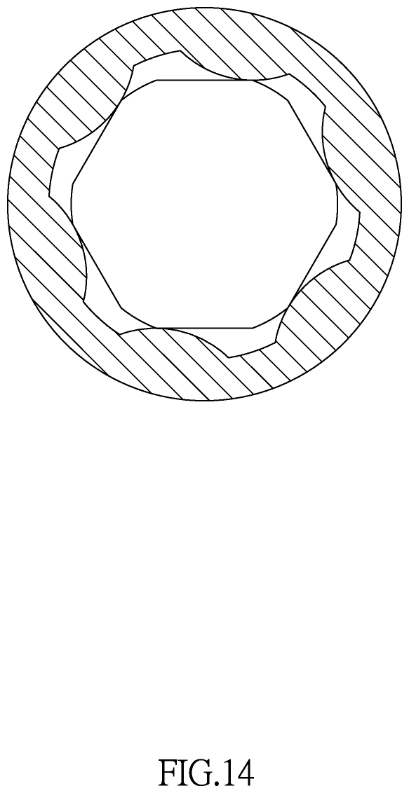

FIG. 15 shows yet another conventional socket and a rounded socket.

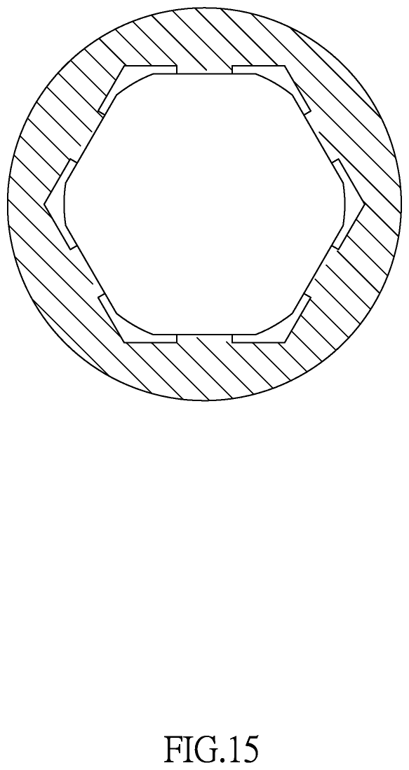

### DETAILED DESCRIPTION OF THE PREFERRED EMBODIMENT

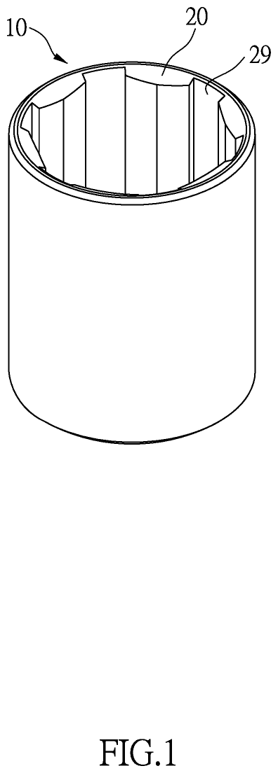

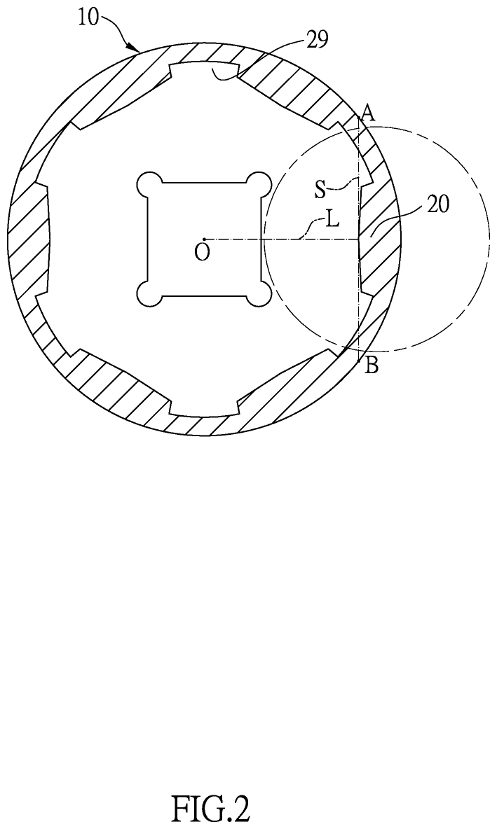

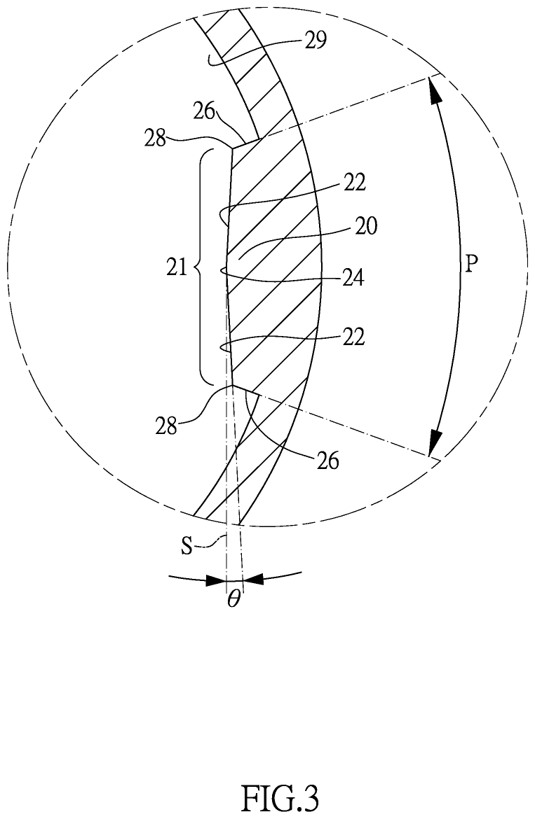

Referring to FIGS. 1 to 3, the socket 10 of the present invention comprises a cylindrical body which has a central hole. Multiple protrusions 20 protrude radially from the inner periphery of the central hole of the socket 10, and multiple grooves 29 are defined in the inner periphery of the central hole and located alternatively between the protrusions 20. Each protrusion 20 has an encounter face 21 formed on the distal end thereof, and the encounter face 21 faces the center “O” of the socket 10. Each encounter face 21 includes two inclined faces 22 which intersect at a peak point 24 by a top angle. Each protrusion 20 also includes two lateral sides 26 which respectively face the grooves 29 corresponding thereto. The two inclined faces 22 respectively intersect the two lateral sides 26 at a corner 28 by a corner angle which is an obtuse angle. The two inclined faces 22 have an identical width. An angle “θ” of 2 to 9 degrees is defined between each of the inclined face 22 and a chord “S” that passes the peak point and intersects point “A” and point “B” on the outer periphery of the socket 10, as shown in FIGS. 2 and 3. The chord “S” is perpendicular to a vertical bisector “L” of the chord “S” (or an axis of the protrusion 20) that passes through the center “O” of the socket 10. The center angle P between the two lateral sides 26 of each protrusion 20 is 25 to 44 degrees.

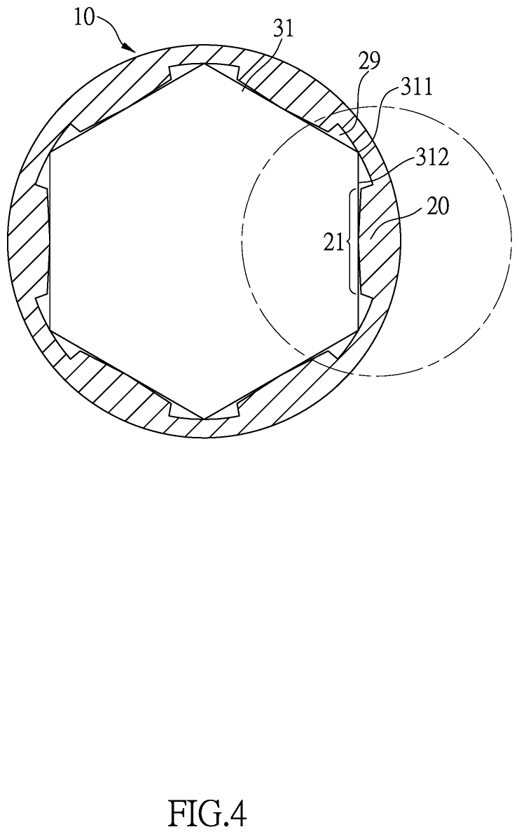

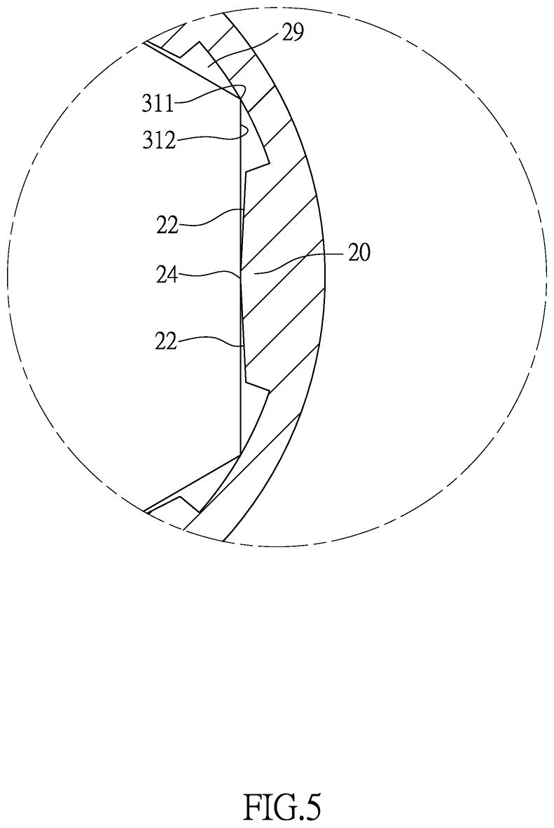

As shown in FIGS. 4 and 5, when a normal object 31 such as a nut or a bolt head is engaged with the central hole of the socket 10, the corners 311 of the object 31 are located corresponding to the grooves 29, and the sides 312 are located corresponding to the encounter faces 20 of the protrusions 20.

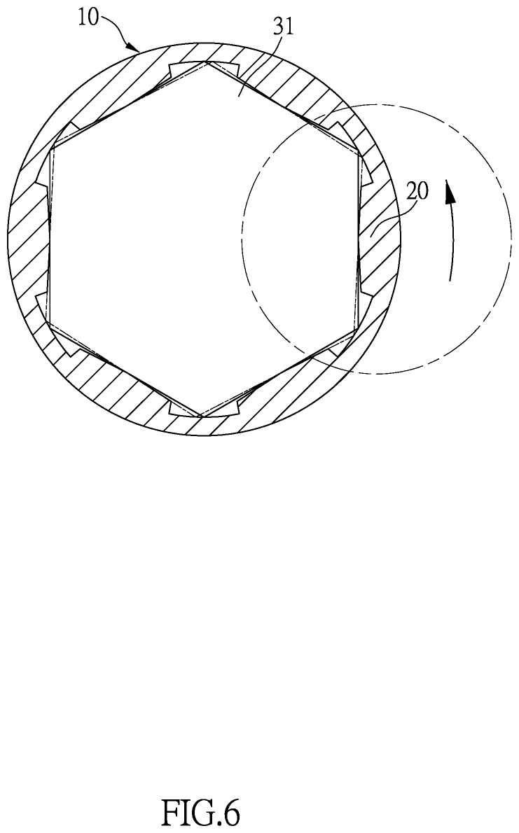

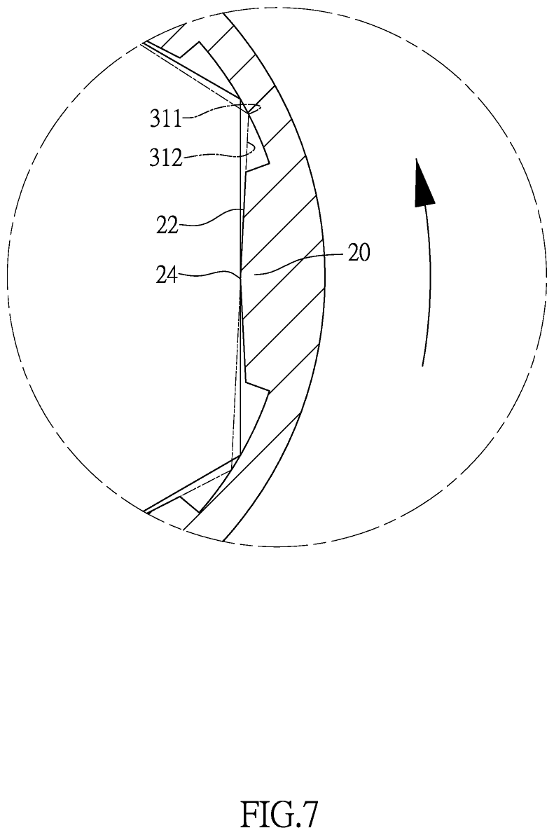

As shown in FIGS. 6 and 7, when the socket 10 is rotated an angle, the peak point 24 and one of the inclined faces 22 of each protrusion 20 contact one of the sides 312 of the object 31 so that the socket 10 is able to rotate the object 31.

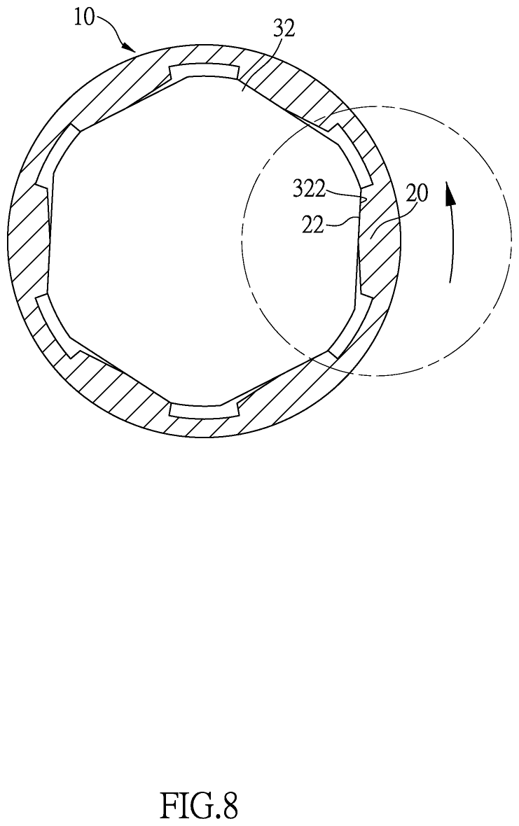

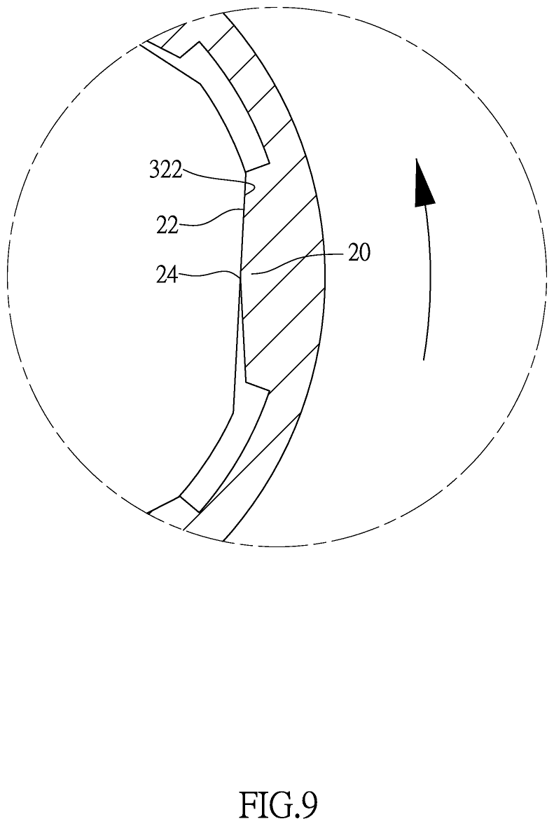

As shown in FIGS. 8 and 9, when a slightly rounded object 32 is engaged with the central hole of the socket 10, and the socket 10 is rotated an angle, the peak point 24 and one of the inclined faces 22 of each protrusion 20 contact one of the sides 322 of the object 32 so that the socket 10 is able to rotate the object 32 successfully.

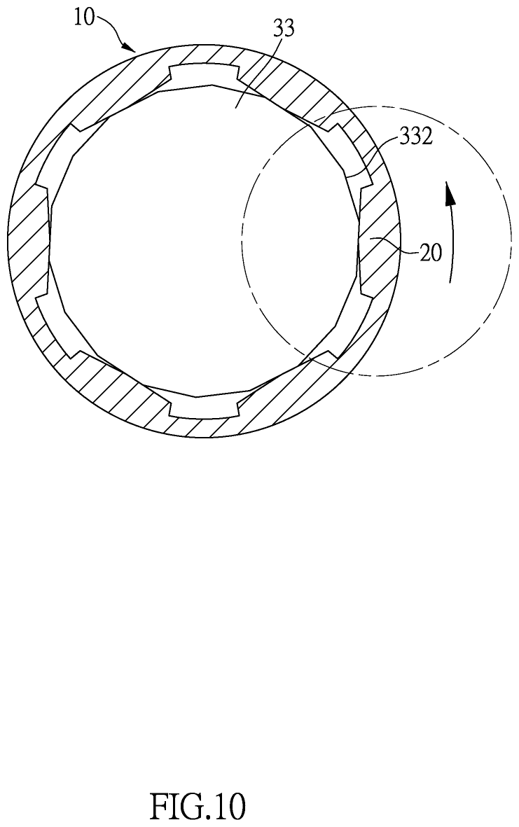

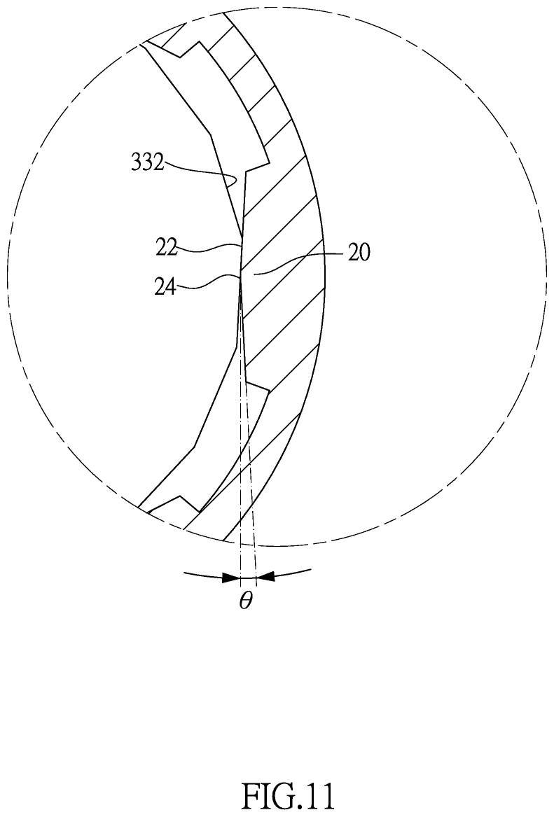

As shown in FIGS. 10 and 11, when a severely rounded object 33 is engaged with the central hole of the socket 10, and the socket 10 is rotated an angle, the peak point 24 and one of the inclined faces 22 of each protrusion 20 contact one of the sides 332 of the object 33 so that the socket 10 is able to rotate the object 32 successfully.

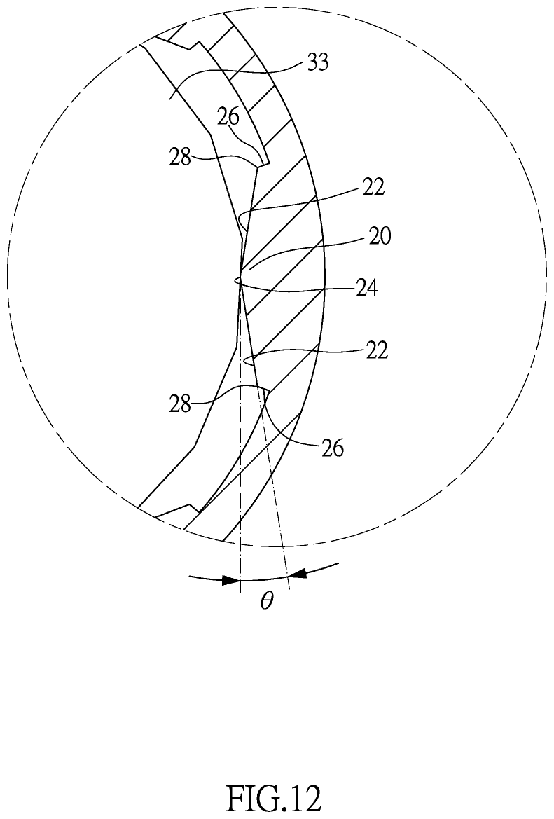

As shown in FIGS. 11 and 12, the different angles “0” result different contact situations between the protrusions 20 and the object 33. As shown in FIG. 11, the angle “θ” is between 2 to 4 degrees, the inclined face 22 contacts one of the sides 332 by an area. As shown in FIG. 12, the angle “θ” is between 9 degrees, the peak point 24 contacts one of the sides 322 by a line. In addition, the peak point 24 forcibly contacts against one of the side 322 of the object 33 to form a “bite-relation” between the peak point 24 and the side 322. Once the peak point 24 bites the side 322, a driving force from the socket to the object 33 is effectively delivered. Therefore, when driving a severely rounded object 33, a larger angle “θ” is chosen to provide as large as possible contact area between the peak point 24 and one of the sides 332, such that the driving force to the severely rounded object 33 is increased, and the severely rounded object 33 can be rotated.

The corner angle at the corner 28 and the top angle at the peak 24 each are an obtuse angle that protects the protrusion 20 from being damaged, and also reinforce the strength of the protrusion 20.

While we have shown and described the embodiment in accordance with the present invention, it should be clear to those skilled in the art that further embodiments may be made without departing from the scope of the present invention.

What is claimed is:

1. A socket comprising:
a cylindrical body having a central hole, multiple protrusions protruding radially from an inner periphery of the central hole of the socket, multiple grooves defined in the inner periphery of the central hole and located alternatively between the protrusions, each protrusion having an encounter face formed on a distal end thereof, the encounter face facing a center of the socket, each encounter face including two inclined faces which intersect at a peak point by a top angle, each protrusion including two lateral sides which respectively face the grooves corresponding thereto, the two inclined faces respectively intersecting the two lateral sides at a corner by a corner angle which is an obtuse angle, the two inclined faces having an identical width, an angle of 2 to 9 degrees being defined between each of the inclined face and a chord that passes the peak point and intersects two respective points on an outer periphery of the socket, the chord being perpendicular to an axis of the protrusion, the axis of the protrusion passing through the center of the socket, a center angle between the two lateral sides of each protrusion being 25 to 44 degrees, wherein the socket having a large angle between each of the inclined face and the chord is used to drive a worn object so that the peak point contacts one of the sides of the object by a line to increase a contact area between the peak point and one of the sides of the object, and to increase a driving force to the object.
